(19) United States
(12) Patent Application Publication
(10) Pub. No.: US 2025/0215170 A1
(43) Pub. Date: Jul. 3, 2025

(54) FLAME-RETARDANT FILM AND DECORATION MATERIAL FILM

(71) Applicant: NAN YA PLASTICS CORPORATION, TAIPEI (TW)

(72) Inventors: TE-CHAO LIAO, TAIPEI (TW); TENG-KO MA, TAIPEI (TW); CHING-YAO YUAN, TAIPEI (TW); HUNG-YI CHANG, TAIPEI (TW); CHAO-QUAN WU, TAIPEI (TW)

(21) Appl. No.: 18/626,455

(22) Filed: Apr. 4, 2024

(30) Foreign Application Priority Data
Dec. 27, 2023 (TW) 112150905

(51) Int. Cl. C08J 5/22; C08K 3/016; C08K 3/22; C08K 9/10; C08L 23/06; C08L 23/12; C08L 23/32

(52) U.S. Cl. CPC C08J 5/22; C08K 3/016; C08K 3/22; C08K 9/10; C08L 23/06; C08L 23/12; C08L 23/32; C08J 2323/06; C08J 2323/12; C08J 2323/18; C08K 2003/2224; C08K 2003/2227; C08K 2201/019; C08L 2201/02; C08L 2205/03; C08L 2207/066

(57) ABSTRACT

A flame-retardant film formed from a resin composition without halogens and a decoration material film manufactured therefrom are provided. The resin composition includes: 12 wt % to 55 wt % of a first polyolefin resin, 20 wt % to 60 wt % of a second polyolefin resin, 3 wt % to 15 wt % of a phosphorus compound with spiro structure, and 15 wt % to 30 wt % of a flame retardant mixture. A phosphorus atom content of the first polyolefin resin ranges from 0.1 wt % to 1.0 wt %. The second polyolefin resin includes a polyethylene and a polypropylene. The flame retardant mixture includes a phosphorus-based flame retardant and further includes at least one selected from the group consisting of a nitrogen-based flame retardant, a silicon-based flame retardant, a boron-based flame retardant, and an inorganic metal flame retardant.

### CROSS-REFERENCE TO RELATED PATENT APPLICATION

This application claims the benefit of priority to Taiwan Patent Application No. 112150905, filed on Dec. 27, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a flame-retardant film and a decoration material film, and more particularly to a flame-retardant film and a decoration material film without halogens.

### BACKGROUND OF THE DISCLOSURE

In a conventional flame-retardant film, a halogen flame retardant is added into a polyolefin resin. The halogen flame retardant has good flame retardancy. However, toxic gases and thick smoke will be produced when the halogen flame retardant is burned, which is harmful to the human body and the environment. Therefore, such materials which contain the halogen flame retardant cannot be used as indoor decoration materials. With the rise of awareness for environmental protection, the relevant industry has been devoted to research of a new material to replace such halogen-containing materials.

Accordingly, how to enhance the flame retardancy of the polyolefin resin by improving components herein so as to replace the existing halogen-containing materials has become an important issued to be addressed.

### SUMMARY OF THE DISCLOSURE

In response to the above-referenced technical inadequacy, the present disclosure provides a flame-retardant film and a decoration material film.

In order to solve the above-mentioned problems, one of the technical aspects adopted by the present disclosure is to provide a flame-retardant film. The flame-retardant film is formed from a resin composition without halogens. The resin composition includes: 12 wt % to 55 wt % of a first polyolefin resin, 20 wt % to 60 wt % of a second polyolefin resin, 3 wt % to 15 wt % of a phosphorus compound with spiro structure, and 15 wt % to 30 wt % of a flame retardant mixture. A phosphorus atom content of the first polyolefin resin ranges from 0.1 wt % to 1.0 wt %. The second polyolefin resin includes a polyethylene and a polypropylene. The flame retardant mixture includes a phosphorus-based flame retardant and further includes at least one selected from the group consisting of a nitrogen-based flame retardant, a silicon-based flame retardant, a boron-based flame retardant, and an inorganic metal flame retardant.

In one of the possible or preferred embodiments, the first polyolefin resin is formed by reacting a phosphorus compound and a polyolefin, and a weight ratio of the phosphorus compound to the polyolefin ranges from 1:10 to 1:100.

In one of the possible or preferred embodiments, the phosphorus compound is selected from the group consisting of a phosphate containing a vinyl group and a phosphate containing a biphenyl group.

In one of the possible or preferred embodiments, the phosphorus compound is a phosphate containing a biphenyl group and a hydroxyl group.

In one of the possible or preferred embodiments, the phosphorus compound is selected from the group consisting of 9,10-dihydro-9-oxa-10-phosphaphenanthrene-10-oxide and 10-(2,5-dihydroxyphenyl)-10H-9-oxa-10-phosphaphenanthrene-10-oxide.

In one of the possible or preferred embodiments, the polyolefin is selected from the group consisting of a polyethylene, a polypropylene, and a polybutylene.

In one of the possible or preferred embodiments, the polyolefin has a terminal epoxy group.

In one of the possible or preferred embodiments, the first polyolefin resin has a functional group, and the functional group is selected from the group consisting of a vinyl group and a biphenyl group.

In one of the possible or preferred embodiments, a phosphorus atom content of the phosphorus compound with spiro structure ranges from 7 wt % to 15 wt %.

In one of the possible or preferred embodiments, the phosphorus compound with spiro structure is bis(2,4-dicumylphenyl) pentaerythritol diphosphite.

In one of the possible or preferred embodiments, the phosphorus-based flame retardant includes a core layer and a shell layer encapsulating the core layer, and the shell layer is a carbonized layer.

In one of the possible or preferred embodiments, the core layer is formed from polymetaphosphate.

In one of the possible or preferred embodiments, the nitrogen-based flame retardant is melamine or its derivatives.

In one of the possible or preferred embodiments, the silicon-based flame retardant is silicon dioxide or siloxane.

In one of the possible or preferred embodiments, the boron-based flame retardant is borate.

In one of the possible or preferred embodiments, the inorganic metal flame retardant is selected from the group consisting of magnesium hydroxide, aluminum hydroxide, and calcium carbonate.

In one of the possible or preferred embodiments, a density of the flame-retardant film ranges from 0.9 g/cm³ to 1.3 g/cm³.

In one of the possible or preferred embodiments, a phosphorus atom content of the overall flame-retardant film ranges from 1.25 wt % to 2.0 wt %.

In order to solve the above-mentioned problems, another one of the technical aspects adopted by the present disclosure is to provide a decoration material film. The decoration material film includes the flame-retardant film mentioned above and a pattern layer disposed on the flame-retardant film.

Therefore, in the flame-retardant film and the decoration material film provided by the present disclosure, by virtue of “the resin composition including the first polyolefin resin, the second polyolefin resin, the phosphorus compound with spiro structure, and the flame retardant mixture” and “the phosphorus atom content of the first polyolefin resin ranging from 0.1 wt % to 1.0 wt %,” the flame-retardant film can have good flame retardancy.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic side view of a flame-retardant film according to the present disclosure; and

FIG. 2 is a schematic side view of a decoration material film according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

In order to overcome the problem of toxic gases and thick smoke which are produced by burning the halogen flame retardant, the present disclosure provides a flame-retardant film and a decoration material film. Even though the halogen flame retardant is absent from the flame-retardant film and the decoration material film of the present disclosure, they are still capable of exhibiting good flame retardancy.

Specific flame-retardant additives and a specific polyolefin material are mixed to form a resin composition. The resin composition can be used to form a flame-retardant film having good flame retardancy by a tape machine, and can be further used to manufacture a flame-retardant decoration material film. The flame-retardant film and the flame-retardant decoration material film are both pleasing to the eye and safe to use, and can replace the conventional flame-retardant film.

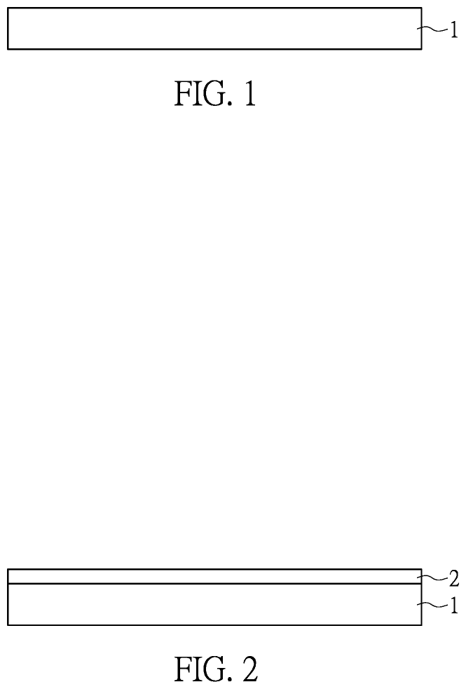

Referring to FIG. 1, the flame-retardant film 1 is formed from a resin composition by a tape machine. In an exemplary embodiment, a thickness of the flame-retardant film 1 ranges from 0.25 mm to 0.75 mm, but the present disclosure is not limited thereto.

Halogens are absent from the resin composition of the present disclosure. Based on a total weight of the resin composition being 100 wt %, the resin composition includes 12 wt % to 55 wt % of a first polyolefin resin, 20 wt % to 60 wt % of a second polyolefin resin, 3 wt % to 15 wt % of a phosphorus compound with spiro structure, and 15 wt % to 30 wt % of a flame retardant mixture.

The first polyolefin resin, the phosphorus compound with spiro structure, and the flame retardant mixture include phosphorus atoms. Under the synergism of the first polyolefin resin, the phosphorus compound with spiro structure, and the flame retardant mixture, the flame-retardant film can have good flame retardancy. Specifically, based on a total weight of the flame-retardant film being 100 wt %, a phosphorus atom content of the flame-retardant film ranges from 1.25 wt % to 2.0 wt %, but the present disclosure is not limited thereto.

The first polyolefin resin and the second polyolefin resin are main components of the flame-retardant film. Based on a total weight of the resin composition being 100 wt %, a total weight of the first polyolefin resin and the second polyolefin resin is higher than 70 wt %. In an exemplary embodiment, an amount of the second polyolefin resin is higher than or equal to an amount of the first polyolefin resin.

### [First Polyolefin Resin]

The addition of the first polyolefin resin enhances the flame retardancy of the resin composition. A phosphorus atom content of the first polyolefin resin ranges from 0.1 wt % to 1.0 wt %.

Specifically, the first polyolefin resin has a phosphorus-containing functional group which can enhance the flame retardancy of the resin composition and compatibility between the flame retardant mixture and the second polyolefin resin.

The first polyolefin resin is formed by reacting a phosphorus compound, a polyolefin, and a peroxide at a temperature ranging from 160° C. to 240° C. In other words, the polyolefin is modified by the phosphorus compound to form the first polyolefin resin, such that the first polyolefin resin has flame retardancy. As a result, the first polyolefin resin is modified to have phosphorus-containing group.

A weight ratio of the phosphorus compound and the polyolefin ranges from 1:10 to 1:100, such that the first polyolefin resin can have a specific content of phosphorous atoms. The phosphorus compound can be a phosphate, a phosphorous-containing compound having a specific functional group, or a phosphorus-containing oxide having a 9,10-dihydro-9-oxa-10-phosphaphenanthrene-10-oxide (DOPO) group, but the present disclosure is not limited thereto.

In an exemplary embodiment, the phosphorus compound can be a phosphate containing a vinyl group, a phosphate containing a biphenyl group, or a combination thereof. In another exemplary embodiment, the phosphorus compound is a phosphate containing a biphenyl group and a hydroxyl group. In yet another exemplary embodiment, the phosphorus compound is 9,10-dihydro-9-oxa-10-phosphaphenanthrene-10-oxide (DOPO), 10-(2,5-dihydroxyphenyl)-10H-9-oxa-10-phosphaphenanthrene-10-oxide (ODOPB), or a combination thereof.

The polyolefin can be a polyethylene, a polypropylene, a polybutylene, or a combination thereof. In addition, the polyolefin can also be a polyolefin having an epoxy group. Preferably, the polyolefin is a polyethylene having a terminal epoxy group, a polypropylene having a terminal epoxy group, and a polybutylene having a terminal epoxy group, but the present disclosure is not limited thereto.

The peroxide can be dicumyl peroxide (DCP), di-tert-butyl peroxide (DTBP), isopropylcumyl hydroperoxide (DBHP), or a combination thereof.

Based on a total weight of the resin composition being 100 wt %, an amount of the first polyolefin resin ranges from 12 wt % to 55 wt %. For example, the amount of the first polyolefin resin can be 15 wt %, 20 wt %, 25 wt %, 30 wt %, 35 wt %, 40 wt %, 45 wt %, or 50 wt %.

### [Second Polyolefin Resin]

The second polyolefin resin includes a polyethylene and a polypropylene. In addition, the polyethylene and the polypropylene do not have phosphorous-containing functional groups. Therefore, the phosphorous atoms are absent from the second polyolefin resin.

By adjusting the amount of the polyethylene and the polypropylene, a texture of the flame-retardant film can be controlled accordingly. In an exemplary embodiment, the amount of polyethylene is higher than the amount of the polypropylene. Specifically, a weight ratio of the polyethylene to the polypropylene ranges from 1.1 to 9. Preferably, the weight ratio of the polyethylene to the polypropylene ranges from 1.5 to 8.5.

By adjusting molecular weights of the polyethylene and the polypropylene, hardness and a processing temperature of the flame-retardant film can be controlled accordingly. In an exemplary embodiment, the polyethylene can be a linear low density polyethylene (having a weight average molecular weight ranging from 100,000 g/mol to 300,000 g/mol), the polypropylene can be a propylene homopolymer (having a weight average molecular weight ranging from 200,000 g/mol to 300,000 g/mol), but the present disclosure is not limited thereto.

Based on the total weight of the resin composition being 100 wt %, an amount of the second polyolefin resin ranges from 20 wt % to 60 wt %. For example, the amount of the second polyolefin resin can be 25 wt %, 30 wt %, 35 wt %, 40 wt %, 45 wt %, 50 wt %, or 55 wt %.

[Phosphorus Compound with Spiro Structure]

The addition of the phosphorus compound with spiro structure can enhance the flame retardancy of the flame-retardant film. Compared to triphenyl phosphate, the phosphorus compound with spiro structure has a higher phosphorus atom content due to its structure, thereby having better flame retardancy.

In an exemplary embodiment, a phosphorus atom content of the phosphorus compound with spiro structure ranges from 7 wt % to 15 wt %.

In an exemplary embodiment, the phosphorus compound has a spiro structure. Preferably, the phosphorus compound with spiro structure can be bis(2,4-dicumylphenyl) pentaerythritol diphosphite, but the present disclosure is not limited thereto.

In an exemplary embodiment, a melting point of the phosphorus compound with spiro structure ranges from 225° C. to 246° C.

Based on the total weight of the resin composition being 100 wt %, an amount of the phosphorus compound with spiro structure ranges from 3 wt % to 15 wt %. For example, the amount of the second polyolefin resin can be 4 wt %, 6 wt %, 8 wt %, 10 wt %, 12 wt %, or 14 wt %.

### [Flame Retardant Mixture]

The flame retardant mixture includes a phosphorus-based flame retardant and further includes at least one selected from the group consisting of a nitrogen-based flame retardant, a silicon-based flame retardant, a boron-based flame retardant, and an inorganic metal flame retardant. Since there is more than one kind of flame retardant, the flame retardant mixture can achieve the flame retardant effect through a plurality of mechanisms, which cannot be achieved by single flame retardant. Among the flame retardant mixture, the phosphorus-based flame retardant makes a great contribution to the flame retardant effect.

In an exemplary embodiment, based on a total weight of the flame retardant mixture being 100 phr, am amount of the phosphorus-based flame retardant ranges from 20 phr to 45 phr. For example, the amount of the phosphorus-based flame retardant can be 25 phr, 30 phr, 35 phr, or 40 phr.

The phosphorus-based flame retardant can be formed by a phosphorus compound. In order to enhance the flame retardancy of the phosphorus-based flame retardant, the phosphorus-based flame retardant includes a core layer and a shell layer encapsulating the core layer. Specifically, the core layer is formed from polymetaphosphate, the shell layer is a carbonized layer, but the present disclosure is not limited thereto.

In an exemplary embodiment, a method for manufacturing the phosphorus-based flame retardant includes: heating a phosphorus compound to form polymetaphosphate; and reacting polymetaphosphate with a resin for a dehydration reaction to form the carbonized layer on a surface. Therefore, the core layer of the phosphorus-based flame retardant is formed from polymetaphosphate, and the shell layer of the phosphorus-based flame retardant is the carbonized layer.

The shell layer of the phosphorus-based flame retardant (i.e., the carbonized layer) is non-flammable, such that the shell layer can block oxygen so as to avoid combustion. Moreover, the carbonized layer has a low thermal conductivity, which can reduce the heat transferred from flame to a substrate, such that a loss rate of the substrate and a generation of combustibles can be decreased.

The nitrogen-based flame retardant will produce carbon dioxide, nitrogen, ammonia, and water vapor when being heated. Hence, a concentration of the oxygen will be diluted. In addition, the heat will be taken away by the convection of the gases, thereby slowing down a progress of combustion. For example, the nitrogen-based flame retardant can be melamine or its derivatives, but the present disclosure is not limited thereto.

The silicon-based flame retardant will carbonize after burning and form a carbonized layer. The carbonized layer is non-flammable and can also block oxygen to avoid combustion. Moreover, the carbonized layer has a low thermal conductivity, which can reduce the heat transferred from the flame to the substrate. For example, the silicon-based flame retardant can be silicon dioxide, siloxane, or a combination thereof, but the present disclosure is not limited thereto.

A mechanism of the boron-based flame retardant is similar to that of the silicon-based flame retardant. The boron-based flame retardant will carbonize after burning and form a carbonized layer. The carbonized layer is non-flammable and can also block oxygen to avoid combustion. Moreover, the carbonized layer has a low thermal conductivity, which can reduce the heat transferred from the flame to the substrate. For example, the boron-based flame retardant can be borate, but the present disclosure is not limited thereto.

The inorganic metal flame retardant contains crystal water which can release water vapor at high temperature environment. The water vapor can dilute a concentration of oxygen and also help retard the progress of combustion. For example, the inorganic metal flame retardant can be magnesium hydroxide, aluminum hydroxide, calcium carbonate, or a combination thereof, but the present disclosure is not limited thereto.

By means of a synergism of the phosphorus-based flame retardant, the nitrogen-based flame retardant, the silicon-based flame retardant, the boron-based flame retardant, and the inorganic metal flame retardant, the flame retardancy of the flame-retardant film can be enhanced.

Based on the total weight of the resin composition being 100 wt %, an amount of the flame retardant mixture ranges from 15 wt % to 30 wt %. For example, the amount of the flame retardant mixture can be 17.5 wt %, 20 wt %, 22.5 wt %, 25 wt %, or 27.5 wt %.

Further, based on the total weight of the resin composition being 100 wt %, the amount of the phosphorus-based flame retardant ranges from 3 wt % to 13 wt % (such as 4 wt %, 6 wt %, 8 wt %, 10 wt %, or 12 wt %), the amount of the nitrogen-based flame retardant ranges from 3 wt % to 7 wt % (such as 4 wt %, 5 wt %, or 6 wt %), the amount of the silicon-based flame retardant ranges from 1 wt % to 5 wt % (such as 2 wt %, 3 wt %, or 4 wt %), the amount of the boron-based flame retardant ranges from 1 wt % to 5 wt % (such as 2 wt %, 3 wt %, or 4 wt %), and the amount of the inorganic metal flame retardant ranges from 1 wt % to 5 wt % (such as 2 wt %, 3 wt %, or 4 wt %). However, the present disclosure is not limited thereto.

### [Experimental Data]

In order to prove that the flame-retardant film of the present disclosure has good flame retardancy, the resin composition includes the components mentioned above, and then the resin composition is put into a tape machine. The resin composition is used to manufacture the flame-retardant film of Tests 1 to 5 at a processing temperature ranging from 170° C. to 250° C.

In Tests 1 to 5, contents of the first polyolefin resin, the second polyolefin resin, the phosphorus compound with spiro structure, and the flame retardant mixture are listed in Table 1. The first polyolefin resin is formed by reacting a phosphorus compound (a phosphate containing a vinyl group), a polyolefin (having a melting flow index ranging from 1.5 g/10 min to 3.0 g/10 min measured according to the ASTM D1238 standard), and a peroxide at a temperature ranging from 160° C. to 240° C. (temperatures of an extruder being 170° C., 180° C., 210° C., 180° C., 170° C., and 160° C. in series). The weight ratio of the phosphorus compound to the polyolefin ranges from 1:10 to 1:100. The second polyolefin resin includes a propylene homopolymer (having a number average molecular weight ranging from 200,000 g/mol to 300,000 g/mol) and a linear low density polyethylene (having a number average molecular weight ranging from 100,000 g/mol to 300,000 g/mol). The phosphorus compound with spiro structure is bis(2,4-dicumylphenyl) pentaerythritol diphosphite. The phosphorous flame retardant is a mixture of a phosphate monoester and a phosphate diester which has a high activity. A weight ratio of the phosphate monoester and the phosphate diester ranges from 1:2 to 1:5. The nitrogen-based flame retardant is melamine. The silicon-based flame retardant is silicon dioxide having a particle size ranging from 10 μm to 50 μm. The boron-based flame retardant is borate. The inorganic metal flame retardant is aluminum hydroxide.

The flame retardancies of the flame-retardant film in Test 1 to Test 5 are measured according to the UL94VTM standard, and the results are listed in Table 2.

According to the UL94VTM standard, a flame retardacy level “VTM-0” indicates that specimens cannot burn with flaming combustion for more than 10 seconds, total flaming combustion time cannot exceed 50 seconds for each set of 5 specimens, no specimen can have glowing combustion remain for longer than 30 seconds after removal of the test flame, specimens cannot burn with flaming or glowing combustion up to the specimen holding clamp, and specimens cannot drip flaming particles that ignite the cotton.

A flame retardacy level “VTM-1” indicates that specimens cannot burn with flaming combustion for more than 30 seconds, total flaming combustion time cannot exceed 250 seconds for each set of 5 specimens, no specimen can have glowing combustion remain for longer than 60 seconds after removal of the test flame, specimens cannot burn with flaming or glowing combustion up to the specimen holding clamp, and specimens cannot drip flaming particles that ignite the cotton.

A flame retardacy level “VTM-2” indicates that specimens cannot burn with flaming combustion for more than 30 seconds, total flaming combustion time cannot exceed 250 seconds for each set of 5 specimens, no specimen can have glowing combustion remain for longer than 60 seconds after removal of the test flame, specimens cannot burn with flaming or glowing combustion up to the specimen holding clamp, and specimens drip flaming particles that ignite the cotton.

TABLE 1

| (phr) | | Test 1 | Test 2 | Test 3 | Test 4 | Test 5 |
|---|---|---|---|---|---|---|
| First polyolefin resin | | 0 | 50 | 40 | 20 | 10 |
| Second | Propylene | 39.08 | 2.24 | 8 | 19.50 | 26.00 |
| polyolefin | homopolymer | | | | | |
| resin | Linear low density | 48.08 | 18.76 | 24 | 34.50 | 40.00 |
| | polyethylene | | | | | |
| Phosphorous compound with | | 3.84 | 5 | 5 | 5 | 5 |
| spiro structure | | | | | | |
| Flame | Phosphorous-based | 0 | 10 | 9 | 7 | 5 |
| retardant | flame retardant | | | | | |
| mixture | Nitrogen-based flame | 0 | 5 | 5 | 5 | 5 |
| | retardant | | | | | |
| | Silicon-based flame | 3 | 3 | 3 | 3 | 3 |
| | retardant | | | | | |
| | Boron-based flame | 3 | 3 | 3 | 3 | 3 |
| | retardant | | | | | |
| | Inorganic metal flame | 3 | 3 | 3 | 3 | 3 |
| | retardant | | | | | |

TABLE 2

| | Test | Test | Test | Test | Test |
|---|---|---|---|---|---|
| | 1 | 2 | 3 | 4 | 5 |
| Flaming combustion time | 41.3 | 8.9 | 21.9 | 26.9 | 35.0 |
| (second) | | | | | |
| Total flaming combustion | — | 44.4 | 109.7 | 134.4 | 175.0 |
| time for each set of 5 | | | | | |
| specimens (second) | | | | | |
| Glowing combustion time | — | 22.0 | 41.0 | 51.5 | 72.3 |
| after removal of the test | | | | | |
| flame (second) | | | | | |
| Whether flaming or glowing | Yes | No | No | No | Yes |
| combustion up to the | | | | | |
| specimen holding clamp | | | | | |
| Whether the specimen drip | Yes | No | Yes | Yes | Yes |
| flaming particles that | | | | | |
| ignite the cotton | | | | | |
| Flame retardacy level | — | VTM-0 | VTM-1 | VTM-2 | — |

According to the results of Table 1 and Table 2, by controlling the contents of the first polyolefin resin, the second polyolefin resin, the flame retardancy of the flame-retardant film can be enhanced. Therefore, the flame-retardant film of the present disclosure can replace the conventional halogen flame-retardant film.

In the resin composition, when the amount of the first polyolefin resin ranges from 20 wt % to 50 wt %, the flame-retardant film can have good flame retardancy. In addition, the amount of the first polyolefin resin can be adjusted according to requirements.

The flame-retardant film of the present disclosure is non-toxic and has safety and high flame retardancy, such that the flame-retardant film can be used as a decoration material film of indoor decoration materials or vehicle interiors.

Referring to FIG. 2, the decoration material film includes the flame-retardant film 1 and a pattern layer 2. The pattern layer 2 is disposed on the flame-retardant film 1. The pattern layer 2 enables the decoration material film to have a pleasure to the eye. Due to the flame-retardant film, the decoration material film is also non-toxic and has safety and good flame retardancy.

### Beneficial Effects of the Embodiment

In conclusion, in the flame-retardant film and the decoration material film provided by the present disclosure, by virtue of “the resin composition including the first polyolefin resin, a second polyolefin resin, a phosphorus compound with spiro structure, and a flame retardant mixture” and “a phosphorus atom content of the first polyolefin resin ranging from 0.1 wt % to 1.0 wt %,” the flame-retardant film can have good flame retardancy.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A flame-retardant film formed from a resin composition without halogens, the resin composition comprising:
12 wt % to 55 wt % of a first polyolefin resin, wherein a phosphorus atom content of the first polyolefin resin ranges from 0.1 wt % to 1.0 wt %;
20 wt % to 60 wt % of a second polyolefin resin, wherein the second polyolefin resin includes a polyethylene and a polypropylene;
3 wt % to 15 wt % of a phosphorus compound with spiro structure; and
15 wt % to 30 wt % of a flame retardant mixture, wherein the flame retardant mixture includes a phosphorus-based flame retardant and further includes at least one selected from the group consisting of a nitrogen-based flame retardant, a silicon-based flame retardant, a boron-based flame retardant, and an inorganic metal flame retardant.

2. The flame-retardant film according to claim 1, wherein the first polyolefin resin is formed by reacting a phosphorus compound and a polyolefin, and a weight ratio of the phosphorus compound to the polyolefin ranges from 1:10 to 1:100.

3. The flame-retardant film according to claim 2, wherein the phosphorus compound is selected from the group consisting of a phosphate containing a vinyl group and a phosphate containing a biphenyl group.

4. The flame-retardant film according to claim 2, wherein the phosphorus compound is a phosphate containing a biphenyl group and a hydroxyl group.

5. The flame-retardant film according to claim 2, wherein the phosphorus compound is selected from the group consisting of 9,10-dihydro-9-oxa-10-phosphaphenanthrene-10-oxide and 10-(2,5-dihydroxyphenyl)-10H-9-oxa-10-phosphaphenantbrene-10-oxide.

6. The flame-retardant film according to claim 2, wherein the polyolefin is selected from the group consisting of a polyethylene, a polypropylene, and a polybutylene.

7. The flame-retardant film according to claim 2, wherein the polyolefin has a terminal epoxy group.

8. The flame-retardant film according to claim 1, wherein the first polyolefin resin has a functional group, and the functional group is selected from the group consisting of a vinyl group and a biphenyl group.

9. The flame-retardant film according to claim 1, wherein a phosphorus atom content of the phosphorus compound with spiro structure ranges from 7 wt % to 15 wt %.

10. The flame-retardant film according to claim 1, wherein the phosphorus compound with spiro structure is bis(2,4-dicumylphenyl) pentaerythritol diphosphite.

11. The flame-retardant film according to claim 1, wherein the phosphorus-based flame retardant includes a core layer and a shell layer encapsulating the core layer, and the shell layer is a carbonized layer.

12. The flame-retardant film according to claim 11, wherein the core layer is formed from polymetaphosphate.

13. The flame-retardant film according to claim 1, wherein the nitrogen-based flame retardant is melamine or its derivatives.

14. The flame-retardant film according to claim 1, wherein the silicon-based flame retardant is silicon dioxide or siloxane.

15. The flame-retardant film according to claim 1, wherein the boron-based flame retardant is borate.

16. The flame-retardant film according to claim 1, wherein the inorganic metal flame retardant is selected from the group consisting of magnesium hydroxide, aluminum hydroxide, and calcium carbonate.

17. The flame-retardant film according to claim 1, wherein a density of the flame-retardant film ranges from 0.9 g/cm³ to 1.3 g/cm³.

18. The flame-retardant film according to claim 1, wherein a phosphorus atom content of the overall flame-retardant film ranges from 1.25 wt % to 2.0 wt %.

19. A decoration material film, comprising:
the flame-retardant film as claimed in claim 1; and
a pattern layer disposed on the flame-retardant film.
